(19) United States
(12) Patent Application Publication
(10) Pub. No.: US 2018/0097298 A1
(43) Pub. Date: Apr. 5, 2018

(54) ELECTRICAL CONNECTOR

(71) Applicant: LOTES CO., LTD, Keelung (TW)

(72) Inventor: Ted Ju, Keelung (TW)

(21) Appl. No.: 15/722,321

(22) Filed: Oct. 2, 2017

Related U.S. Application Data
(60) Provisional application No. 62/404,395, filed on Oct. 5, 2016.

(30) Foreign Application Priority Data
Jan. 10, 2017 (CN) 201720023371.0

(51) Int. Cl. H01R 9/03; H01R 13/405; H01R 13/6581; H01R 13/631

(52) U.S. Cl. CPC H01R 9/03; H01R 13/631; H01R 13/6581; H01R 13/405

(57) ABSTRACT

An electrical connector includes an insulating body having a base and a tongue located at a front end of the base, a shielding shell sleeving the base and the tongue to form a mating space, and multiple upper-row terminals and multiple lower-row terminals fixedly on the base. Each terminal has a contacting portion, a soldering portion extending out of the base, and a connecting portion located between the contacting portion and the soldering portion. The connecting portion of an upper-row ground terminal and the connecting portion of a lower-row ground terminal are soldered.

### CROSS-REFERENCE TO RELATED APPLICATION

This application claims priority and the benefit of U.S. Provisional Application No. 62/404,395, filed on Oct. 5, 2016, the entire contents of which are hereby incorporated by reference.

### FIELD OF THE INVENTION

The present invention relates to an electrical connector, and more particularly to an electrical connector capable of decreasing electromagnetic interference.

### BACKGROUND OF THE INVENTION

With the development of an electronic technology, signals transmitted by an electrical connector more tend to a high frequency and a high speed. Therefore, a higher requirement is proposed for a shielding structure of the electrical connector, and the shielding structure is required to have a better and more stable grounding effect, so as to meet demands of the nowadays society for a high-frequency transmission performance of the electrical connector.

An existing electrical connector having a shielding structure includes an insulating body. The insulating body is disposed with multiple signal terminals and at least one ground terminal. The ground terminal has a fixing portion and a soldering portion extending backward from the fixing portion. The fixing portion is fixed to the insulating body. The soldering portion is soldered to a circuit board to be grounded. The insulating body is sleeved in a shielding shell used for shielding signal interference of the outside to the signal terminals, so as to form a shielding structure.

However, since the soldering portion is soldered to the circuit board to be grounded, if the soldering portion is poorly soldered or loosened, signal transmission of the signal terminals will be influenced, and the high-frequency transmission performance of the electrical connector will be influenced.

Therefore, a heretofore unaddressed need exists in the art to address the aforementioned deficiencies and inadequacies.

### SUMMARY OF THE INVENTION

In one aspect, the present invention relates to an electrical connector capable of decreasing electromagnetic interference. By soldering middle sections of upper-row ground terminals and middle sections of lower-row ground terminals, the grounding effect of the electrical connector is enhanced.

In certain embodiments, an electrical connector includes an insulating body having a base and a tongue located at a front end of the base, a shielding shell sleeving outside the base and the tongue to form a mating space, and multiple upper-row terminals and multiple lower-row terminals respectively fixedly on the base. Each of the upper-row terminals and lower row terminals has a contacting portion exposed from an upper surface of the tongue or a lower surface of the tongue, a soldering portion extending out of the base, and a connecting portion located between the contacting portion and the soldering portion. The multiple upper-row terminals and the multiple lower-row terminals have at least one upper-row ground terminal and at least one lower-row ground terminal respectively, and the connecting portion of the upper-row ground terminal and the connecting portion of the lower-row ground terminal are soldered.

In certain embodiments, a first extending portion extends transversely from the connecting portion of the upper-row ground terminal, a second extending portion extends transversely from the connecting portion of the lower-row ground terminal, a flat plate portion extends from the second extending portion, and a plate edge of the first extending portion and the flat plate portion are soldered by means of a solder.

In certain embodiments, a receiving hole is provided downward from a top surface of the base, the solder is provided in the receiving hole and located on the flat plate portion, and the plate edge of the first extending portion and the flat plate portion are soldered in the receiving hole.

In certain embodiments, the first extending portion has a front plate edge, and the solder and the front plate edge are soldered.

In certain embodiments, a middle shielding sheet includes a main body portion located between the contacting portions of the upper-row terminals and the contacting portions of the lower-row terminals, a middle section portion extends from the main body portion backward into the base, a third extending portion extends transversely from the middle section portion, a plate edge of the third extending portion is exposed in the receiving hole, and the plate edge of the first extending portion, the flat plate portion and the plate edge of the third extending portion are soldered in the receiving hole.

In certain embodiments, the electrical connector further includes an insulating shell. A receiving cavity runs through the insulating shell along a front-rear direction, and the shielding shell is located in the receiving cavity. A rear cover extends from the insulating shell. An inner wall surface of the rear cover urges against an outer wall surface of the shielding shell. A first glue pouring slot is formed between an inner side wall of the rear cover and an outer side wall of the shielding shell, and a second glue pouring slot is formed between the inner side wall of the rear cover and the base.

In certain embodiments, a glue accommodating slot is recessed in a bottom surface of the base. A third glue pouring slot is formed between the glue accommodating slot and the shielding shell. Multiple lower-row terminals are partially exposed from the third glue pouring slot. The first glue pouring slot, the second glue pouring slot and the third glue pouring slot are communicated with one another, and a sealing piece is located in the first glue pouring slot, the second glue pouring slot and the third glue pouring slot.

In certain embodiments, an accommodating slot is recessed in an upper surface of the insulating shell, at least one through hole is located at two sides of the insulating shell, a fixing member is located in the accommodating slot, and at least one soldering pin extends from the fixing member to penetrate through the through hole.

In certain embodiments, an annular groove is recessed in a front end of the insulating shell, and a waterproof ring is located in the annular groove.

In certain embodiments, at least one stopping portion extends into the mating space from the shielding shell, at least one positioning slot is recessed in the base to run through a front surface of the base, and the stopping portion is located in the positioning slot.

In another aspect, the present invention relates to an electrical connector. In certain embodiments, the electrical connector includes an insulating body having a base and a tongue located at a front end of the base, a shielding shell sleeving outside the base and the tongue to form a mating space, and multiple upper-row terminals and multiple lower-row terminals respectively fixedly on the base. Each of the upper-row terminals and the lower-row terminals has a contacting portion exposed from an upper surface or a lower surface of the tongue, a soldering portion extending out of the base, and a connecting portion located between the contacting portion and the soldering portion. The upper-row terminals and the lower-row terminals have at least one upper-row ground terminal and at least one lower-row ground terminal respectively, and the connecting portion of the upper-row ground terminal urges against the connecting portion of the lower-row ground terminal.

In certain embodiments, a first extending portion extends transversely from the connecting portion of the upper-row ground terminal, and a second extending portion extends transversely from the connecting portion of the lower-row ground terminal. The first extending portion is bent downward to form a first urging portion, the second extending portion is bent upward to form a second urging portion, and the first urging portion urges against the second urging portion.

In certain embodiments, a middle shielding sheet includes a main body portion located between the contacting portions of the upper-row terminals and the contacting portions of the lower-row terminals, a middle section portion extends backward from the main body portion into the base, a third extending portion extends transversely from the middle section portion, and the first urging portion and the second urging portion respectively urge against the third extending portion.

In certain embodiments, the electrical connector further includes an insulating shell. A receiving cavity runs through the insulating shell along a front-rear direction. The shielding shell is located in the receiving cavity. A rear cover extends from the insulating shell. An inner wall surface of the rear cover urges against an outer wall surface of the shielding shell. A first glue pouring slot is formed between an inner side wall of the rear cover and an outer side wall of the shielding shell, and a second glue pouring slot is formed between the inner side wall of the rear cover and the base.

In certain embodiments, a glue accommodating slot is recessed in a lower surface of the base. A third glue pouring slot is formed between the glue accommodating slot and the shielding shell. Multiple lower-row terminals are partially exposed from the third glue pouring slot. The first glue pouring slot, the second glue pouring slot and the third glue pouring slot are communicated with one another, and a sealing piece is located in the first glue pouring slot, the second glue pouring slot and the third glue pouring slot.

In certain embodiments, an accommodating slot is recessed in an upper surface of the insulating shell. One through hole is also located at two sides of the insulating shell. A fixing member is located in the accommodating slot. A soldering pin extends from the fixing member to penetrate through the through hole.

In certain embodiments, an annular groove is recessed in a front end of the insulating shell, and a waterproof ring is located in the annular groove.

In certain embodiments, at least one stopping portion extends into the mating space from the shielding shell, at least one positioning slot is recessed in the base to run through a front surface of the base, and the stopping portion is located in the positioning slot.

Compared with the related art, certain embodiments of the present invention have the advantages that a connecting portion of an upper-row ground terminal and a connecting portion of a lower-row ground terminal are soldered. By means of such a structure, there are more grounded parts of the electrical connector, the grounding area is larger, and the grounding effect is enhanced. Moreover, when a soldering portion of the upper-row ground terminal is loosened or poorly soldered, grounding can be realized by means of a soldering portion of the lower-row ground terminal, thereby ensuring a high-frequency performance. Or, when the soldering portion of the lower-row ground terminal is loosened or poorly soldered, grounding can be realized by means of the soldering portion of the upper-row ground terminal, thereby ensuring the high-frequency transmission performance.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional exploded view of an electrical connector according to one embodiment of the present invention.

FIG. 2 is a schematic three-dimensional exploded view of the electrical connector according to one embodiment of the present invention viewed from another angle.

FIG. 3 is a schematic three-dimensional partial assembly view of the electrical connector according to one embodiment of the present invention.

FIG. 4 is a schematic three-dimensional partial assembly view of the electrical connector according to one embodiment of the present invention viewed from another angle.

FIG. 5 is a schematic three-dimensional assembly view of the electrical connector according to one embodiment of the present invention.

FIG. 6 is a local sectional view of the electrical connector according to one embodiment of the present invention.

FIG. 7 is a local section view of the electrical connector according to one embodiment of the present invention viewed from another angle.

FIG. 8 is a local section view of the electrical connector according to one embodiment of the present invention viewed from another angle.

FIG. 9 is a three-dimensional exploded view of an electrical connector according to a second embodiment of the present invention.

FIG. 10 is a three-dimensional exploded view of the electrical connector according to a second embodiment of the present invention viewed from another angle.

FIG. 11 is an enlarged view of part a in FIG. 10.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

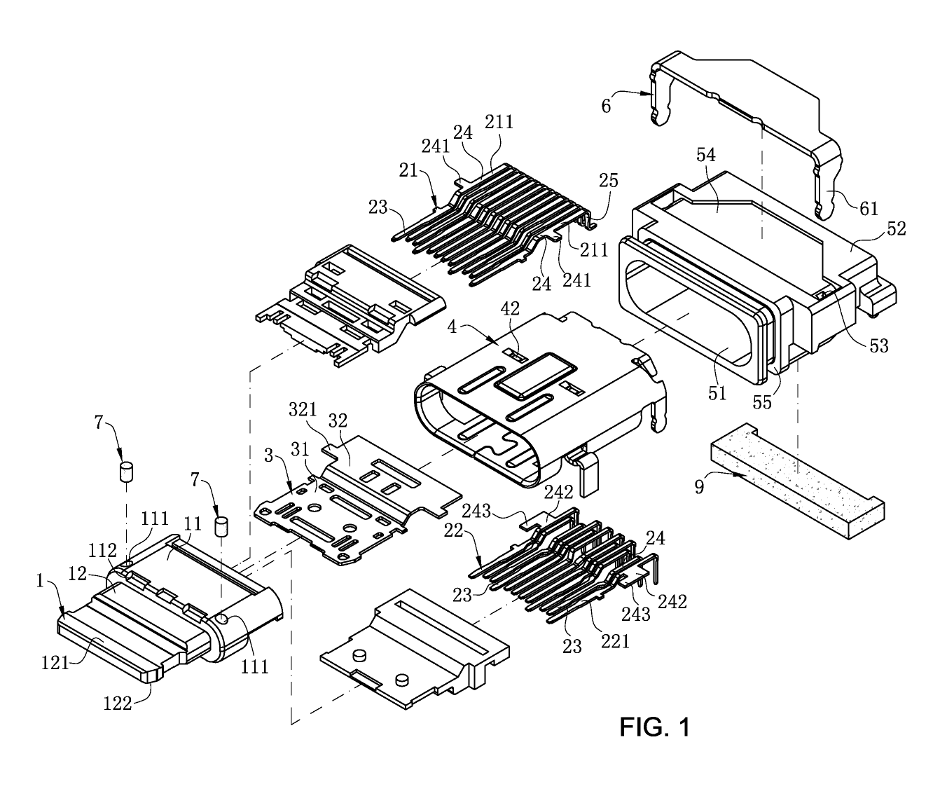

The description will be made as to the embodiments of the present invention in conjunction with the accompanying drawings in FIGS. 1-11. In accordance with the purposes of this invention, as embodied and broadly described herein, this invention, in one aspect, relates to an electrical connector.

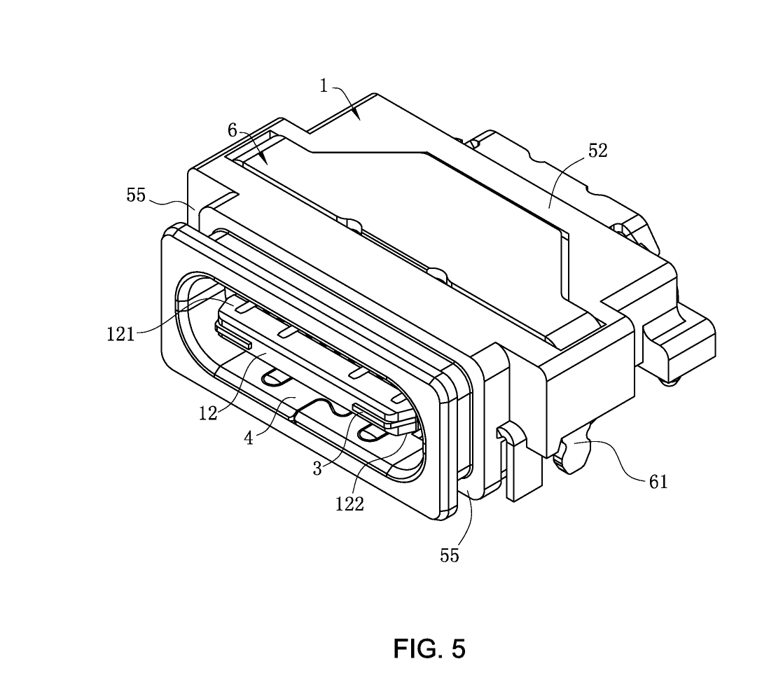

As shown in FIG. 5, an electrical connector according to one embodiment of the present invention includes an insulating body 1, multiple upper-row terminals 21, multiple lower-row terminals 22 and a middle shielding sheet 3 disposed in the insulating body 1, a shielding shell 4 sleeving outside the insulating body 1, an insulating shell 5 wrapping the shielding shell 4, and a sealing piece 9 sealing a tail end of the electrical connector.

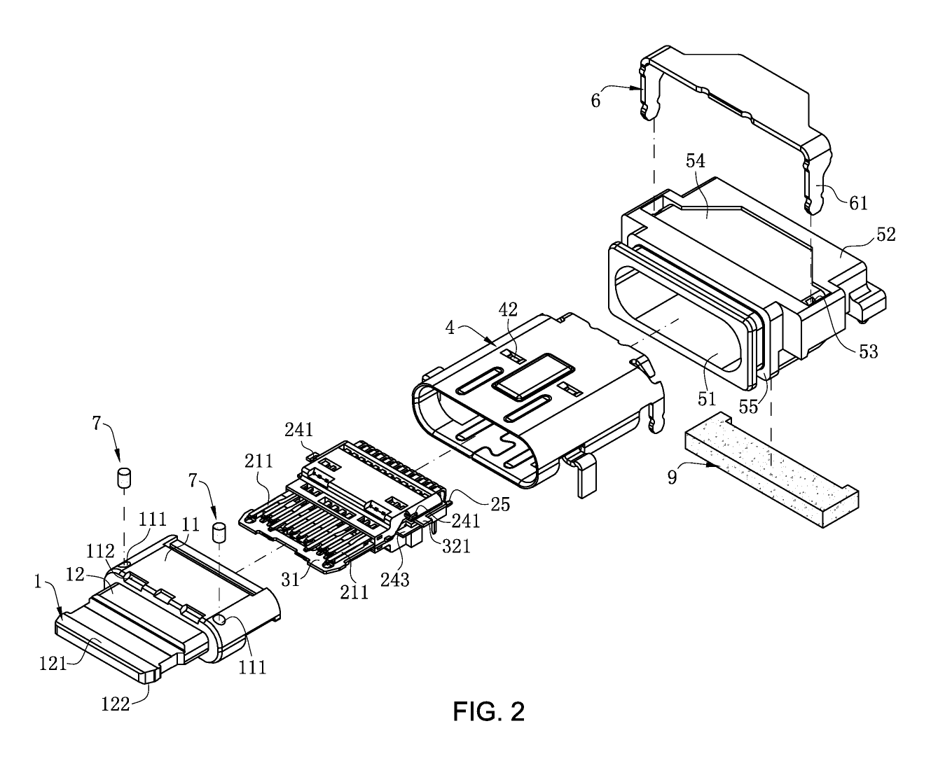

FIG. 1 and FIG. 2 show a first embodiment of the present invention. As shown in FIG. 1 and FIG. 2, the insulating body 1 has a base 11 and a tongue 12 located at a front end of the base 11. Two receiving holes 111 are provided downward from a top surface of the base 11, and the receiving holes 111 are located on two sides of the base 11. A glue accommodating slot 113 is recessed in a bottom surface of the base 11. A third glue pouring slot 83 is formed between the glue accommodating slot 113 and the shielding shell 4. Four positioning slots 112 are recessed in a front surface of the base 11.

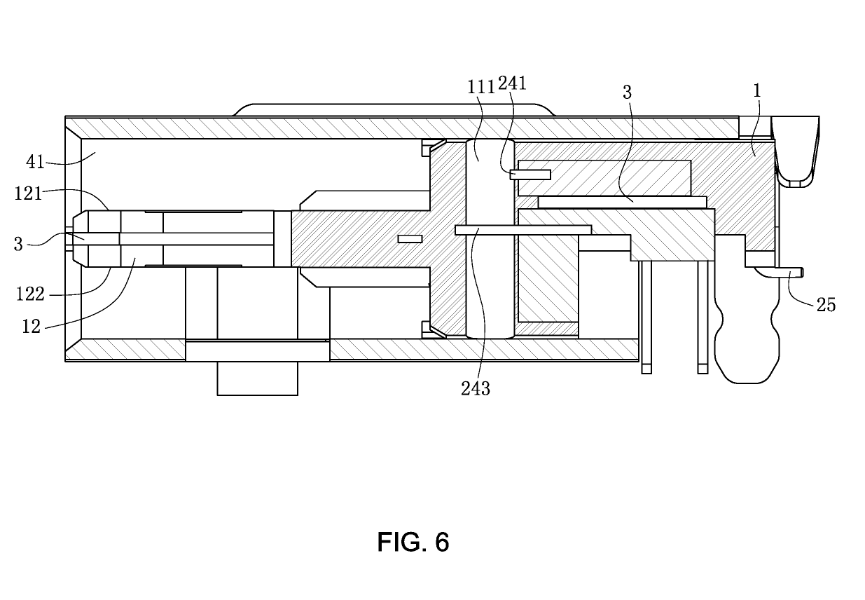

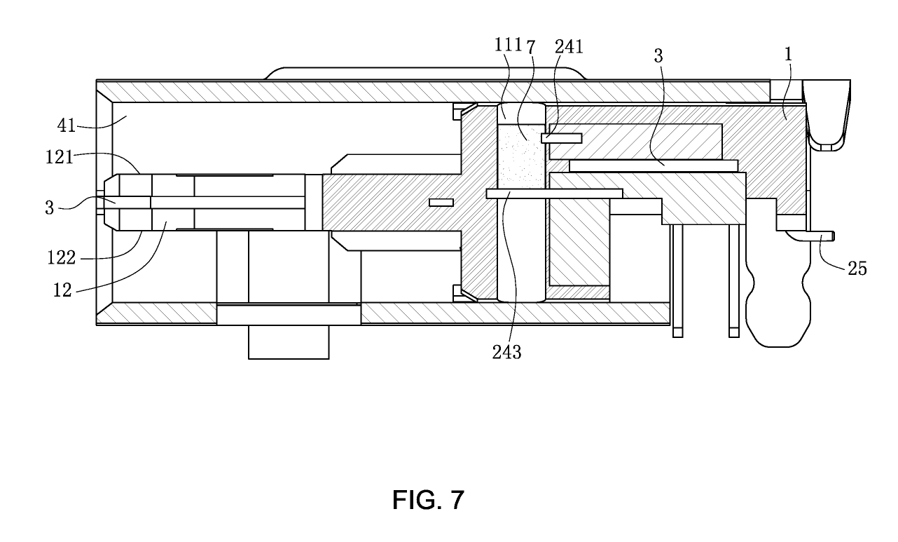

The tongue 12 has an upper surface 121 and an opposite, lower surface 122. The upper-row terminals 21 and the lower-row terminals 22 are respectively fixedly on the base 11. Each upper-row terminal 21 and each lower-row terminal 22 have a contacting portion 23 respectively exposed from an upper surface 121 and lower surface 122 of the tongue 12. A soldering portion 25 extends out of the base 11. A connecting portion 24 is located between the contacting portion 23 and the soldering portion 25. The upper-row terminals 21 and the lower-row terminals 22 respectively have two upper-row ground terminals 211 and two lower-row ground terminals 221. A first extending portion 241 extends transversely from a connecting portion 24 of each upper-row ground terminal 211. A second extending portion 242 extends transversely from a connecting portion 24 of each lower-row ground terminal 221. The second extending portion 242 has a front plate edge, a rear plate edge and a side plate edge. A flat plate portion 243 extends from the second extending portion 242 forward. A front plate edge of the first extending portion 241 and the flat plate portion 243 are exposed in the corresponding receiving hole 111 (as shown in FIG. 6). A solder 7 is provided in the receiving hole 111 and located on the flat plate portion 243 (as shown in FIG. 7), and the front plate edge of the first extending portion 241 and the flat plate portion 243 are soldered in the receiving hole 111.

A middle shielding sheet 3 includes a main body portion 31 located between the contacting portions 23 of the upper-row terminals 21 and the contacting portions 23 of the lower-row terminals 22. A middle section portion 32 extends backward into the base 11 from the main body portion 31. A third extending portion 321 extends transversely from the middle section portion 32. The third extending portion 321 has a front plate edge, a rear plate edge and a side plate edge. The front plate edge of the third extending portion 321 is exposed in the receiving hole 111 (not shown), and the front plate edge of the first extending portion 241, the flat plate portion 243 and the front plate edge of the third extending portion 321 are soldered in the receiving hole 111 (not shown).

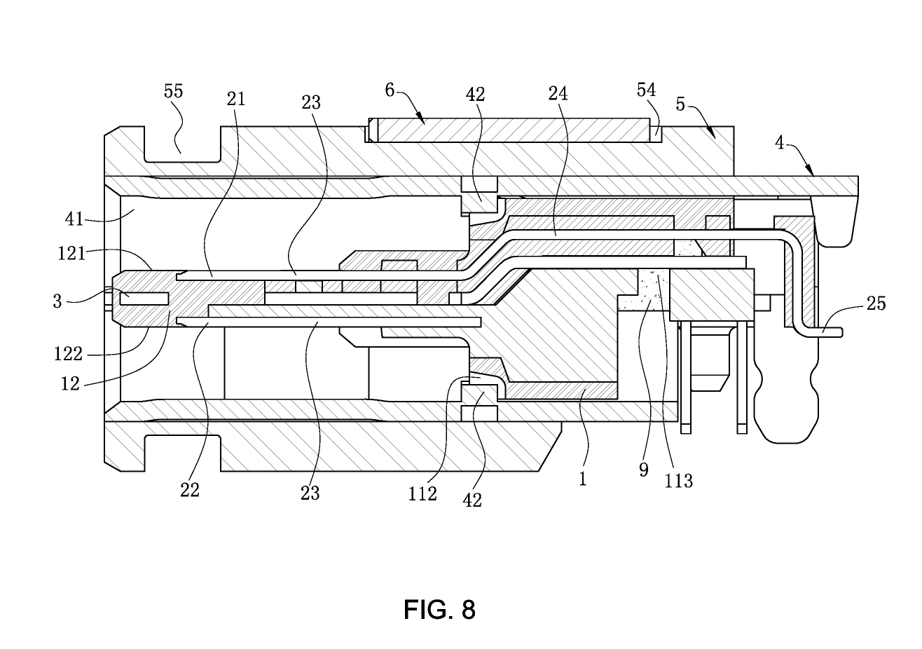

The shielding shell 4 sleeves outside the insulating body 1 to form a mating space 41. Four stopping portions 42 extend to positions corresponding to the positioning slots 112 in the mating space 41 from the shielding shell 4. The stopping portions 42 are respectively located in the positioning slots 112 (as shown in FIG. 8).

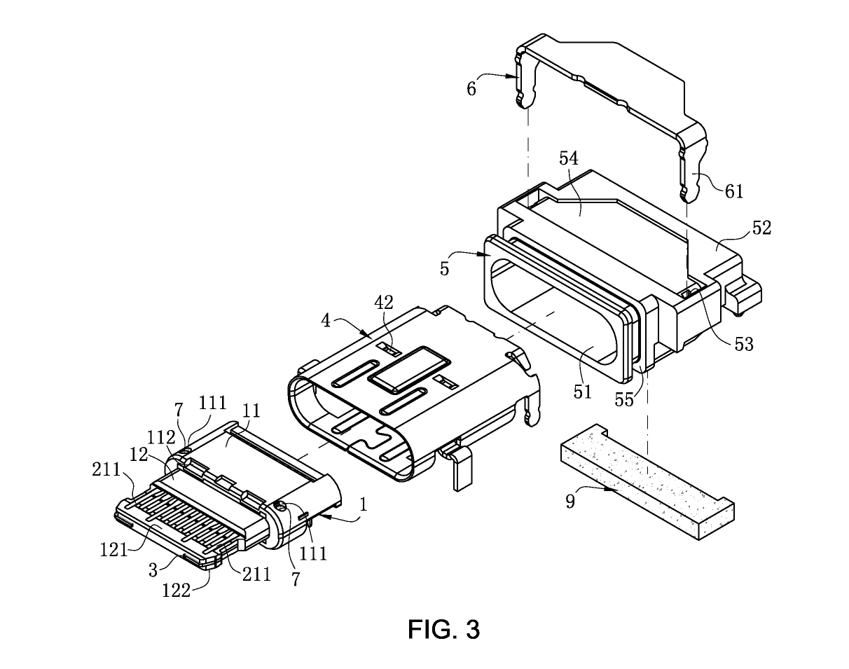

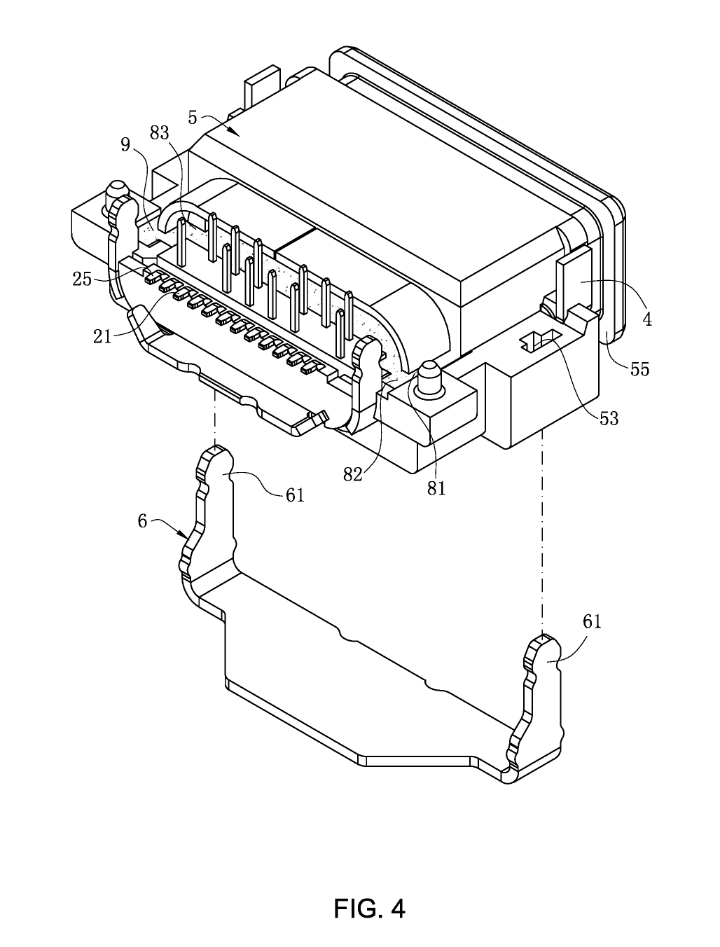

As shown in FIG. 3 and FIG. 4, the insulating shell 5 has a receiving cavity 51 running through the insulating shell 5 along a front-rear direction, and the shielding shell 4 is located in the receiving cavity 51. A rear cover 52 extends from the insulating shell 5. An inner wall surface of the rear cover 52 urges against an outer wall surface of the shielding shell 4. A first glue pouring slot 81 is formed between an inner side wall of the rear cover 52 and an outer side wall of the shielding shell 4, and a second glue pouring slot 82 is formed between the inner side wall of the rear cover 52 and the base 11. An accommodating slot 54 is recessed in an upper surface of the insulating shell 5. Through holes 53 are provided at two sides of the insulating shell 5. A fixing member 6 is located in the accommodating slot 54. A soldering pin 61 extends from the fixing member 6 to penetrate through each of the through holes 53, and the soldering pins 61 are soldered on a circuit board. An annular groove 55 is recessed in a front end of the insulating shell 5, and a waterproof ring (not shown) is located in the annular groove 55. The sealing piece 9 is located in the first glue pouring slot 81, the second glue pouring slot 82 and the third glue pouring slot 83, and is formed by solidifying waterproof glue.

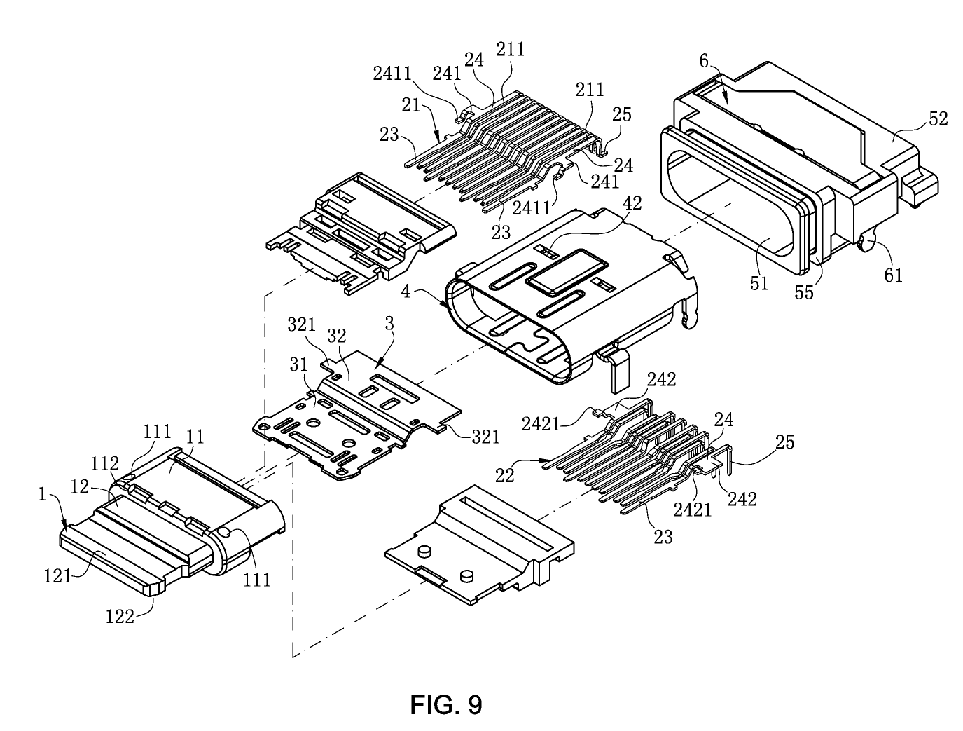

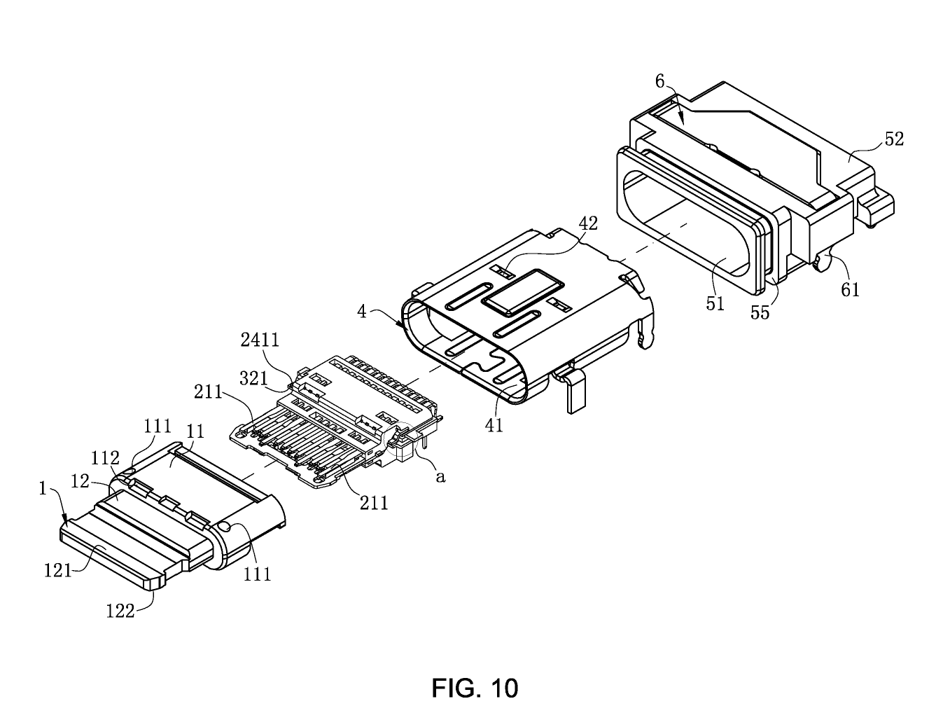

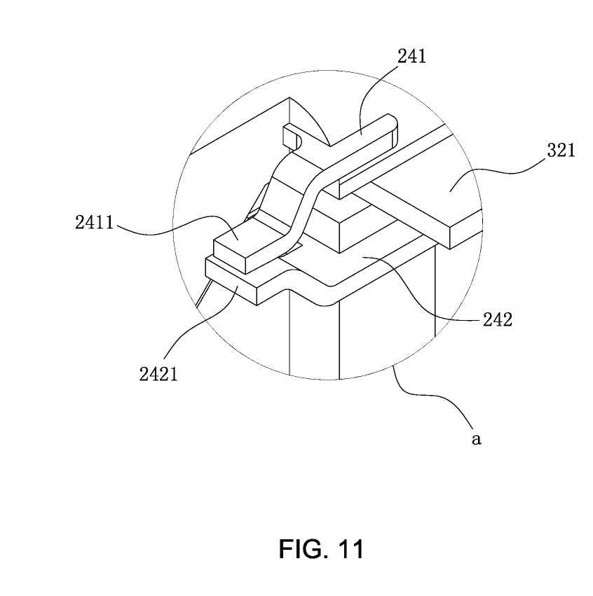

FIG. 9, FIG. 10 and FIG. 11 show a second embodiment of the present invention. The second embodiment differs from the first embodiment in that: the first extending portion 241 is bent downward to form a first urging portion 2411, the second extending portion 242 is bent upward to form a second urging portion 2421, and the first urging portion 2411 urges against the second urging portion 2421. In other embodiments, the first urging portion 2411 and the second urging portion 2421 respectively urge against the third extending portion 321 (not shown), which will not be elaborated herein.

In summary, the electrical connector according to certain embodiments of the present invention has the following beneficial advantages.

(1) In the present invention, the connecting portion 24 of the upper-row ground terminal 211 and the connecting portion 24 of the lower-row ground terminal 221 are soldered. By means of such a structure, there are more grounded parts of the electrical connector, the grounding area is larger, and the grounding effect is enhanced. Moreover, when the soldering portions 25 of the upper-row ground terminal 211 are loosened or poorly soldered, grounding can be realized by means of the soldering portions 25 of the lower-row ground terminals 221, thereby ensuring a high-frequency performance. Or, when the soldering portions 25 of the lower-row ground terminals 221 are loosened or poorly soldered, grounding can be realized by means of the soldering portions 25 of the upper-row ground terminals 211, thereby ensuring the high-frequency transmission performance.

(2) The receiving holes 111 are provided in two sides of the base 11, the solders 7 are provided in the receiving holes 111 and located on the flat plate portion 243, and the front plate edge of the first extending portion 241 and the flat plate portion 243 are exposed from the receiving holes 111. During soldering, the flat plate portion 243 stops the solders 7 from flowing downward to prevent the solders 7 from being lost, the front plate edge of the first extending portion 241 and the flat plate portion 243 can be completely and accurately soldered due to fusion of the solders 7, and soldering is more stable.

(3) The annular groove 55 is recessed in the front end of the insulating shell 5, and the waterproof ring is located in the annular groove 55, thereby stopping water vapor from entering an electronic product from a gap between the electrical connector and the electronic product, and achieving an external waterproof effect.

(4) The four stopping portions 42 extend into the mating space 41 from the shielding shell 4, the stopping portions 42 are located in the positioning slots 112 to stop the insulating body 1 from shifting forwards, and the stopping blocks further protect the insulating body 1 from being damaged due to over-insertion of a mating connector in an insertion process, thereby making the insulating body 1 more stable.

(5) The sealing piece 9 is located in the first glue pouring slot 81, the second glue pouring slot 82 and the third glue pouring slot 83, and seals the tail part of the electrical connector to stop water vapor from entering the tail part from the mating space 41, thereby achieving an internal waterproof effect.

(6) The soldering pin 61 extends from the fixing member 6 and penetrates through the corresponding through hole 53, the soldering pin 61 is soldered on the circuit board, and the electrical connector is fixed to the circuit board to prevent the electrical connector from shifting due to high insertion frequency, thereby making the electrical connector more stable.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body, having a base and a tongue located at a front end of the base;
a shielding shell, sleeving the base and the tongue to form a mating space; and
a plurality of upper-row terminals and a plurality of lower-row terminals, respectively fixed on the base,
wherein each of the upper-row terminals and the lower row terminals comprises a contacting portion exposed respectively from an upper surface and a lower surface of the tongue, a soldering portion extending out of the base, and a connecting portion located between the contacting portion and the soldering portion; and
wherein the upper-row terminals and the lower-row terminals respectively have at least one upper-row ground terminal and at least one lower-row ground terminal, and the connecting portion of the upper-row ground terminal and the connecting portion of the lower-row ground terminal are soldered together.

2. The electrical connector of claim 1, wherein a first extending portion extends transversely from the connecting portion of the upper-row ground terminal, a second extending portion extends transversely from the connecting portion of the lower-row ground terminal, a flat plate portion extends from the second extending portion, and a plate edge of the first extending portion and the flat plate portion are soldered by a solder.

3. The electrical connector of claim 2, wherein a receiving hole is provided downward from a top surface of the base, the solder is provided in the receiving hole and located on the flat plate portion, and the plate edge of the first extending portion and the flat plate portion are soldered in the receiving hole.

4. The electrical connector of claim 3, wherein the first extending portion has a front plate edge, and the solder and the front plate edge are soldered.

5. The electrical connector of claim 3, further comprising a middle shielding sheet, the middle shielding sheet comprising:
a main body portion located between the contacting portions of the upper-row terminals and the contacting portions of the lower-row terminals;
a middle section portion extending backward from the main body portion and into the base; and
a third extending portion extending transversely from the middle section portion,
wherein a plate edge of the third extending portion is exposed in the receiving hole, and the plate edge of the first extending portion, the flat plate portion and the plate edge of the third extending portion are soldered in the receiving hole.

6. The electrical connector of claim 1, further comprising an insulating shell, wherein a receiving cavity runs through the insulating shell along a front-rear direction, the shielding shell is located in the receiving cavity, a rear cover extends from the insulating shell, an inner wall surface of the rear cover urges against an outer wall surface of the shielding shell, a first glue pouring slot is formed between an inner side wall of the rear cover and an outer side wall of the shielding shell, and a second glue pouring slot is formed between the inner side wall of the rear cover and the base.

7. The electrical connector of claim 6, wherein a glue accommodating slot is recessed in a bottom surface of the base, a third glue pouring slot is formed between the glue accommodating slot and the shielding shell, the lower-row terminals are partially exposed from the third glue pouring slot, the first glue pouring slot, the second glue pouring slot and the third glue pouring slot are communicated with each other, and a sealing piece is located in the first glue pouring slot, the second glue pouring slot and the third glue pouring slot.

8. The electrical connector of claim 6, wherein an accommodating slot is recessed in an upper surface of the insulating shell, at least one through hole is located at one of two sides of the insulating shell, the electrical connector further comprises a fixing member located in the accommodating slot, and at least one soldering pin extends from the fixing member to penetrate through the through hole.

9. The electrical connector of claim 6, wherein an annular groove is recessed in a front end of the insulating shell, and a waterproof ring is located in the annular groove.

10. The electrical connector of claim 1, wherein at least one stopping portion extends into the mating space from the shielding shell, at least one positioning slot is recessed in the base to run through a front surface of the base, and the stopping portion is located in the positioning slot.

11. An electrical connector, comprising:
an insulating body, having a base and a tongue located at a front end of the base;
a shielding shell, sleeving the base and the tongue to form a mating space; and
a plurality of upper-row terminals and a plurality of lower-row terminals, respectively fixedly on the base,
wherein each of the upper-row terminals and the lower row terminals comprises a contacting portion exposed respectively from an upper surface and a lower surface of the tongue, a soldering portion extending out of the base, and a connecting portion located between the contacting portion and the soldering portion; and
wherein the upper-row terminals and the lower-row terminals respectively have at least one upper-row ground terminal and at least one lower-row ground terminal, and the connecting portion of the upper-row ground terminal urges against the connecting portion of the lower-row ground terminal.

12. The electrical connector of claim 11, wherein a first extending portion extends transversely from the connecting portion of the upper-row ground terminal, a second extending portion extends transversely from the connecting portion of the lower-row ground terminal, the first extending portion is bent downward to form a first urging portion, the second extending portion is bent upward to form a second urging portion, and the first urging portion urges against the second urging portion.

13. The electrical connector of claim 12, further comprising a middle shielding sheet, the middle shielding sheet comprising:
a main body portion located between the contacting portions of the upper-row terminals and the contacting portions of the lower-row terminals;
a middle section portion extending backward from the main body portion into the base; and
a third extending portion extending transversely from the middle section portion,
wherein the first urging portion and the second urging portion respectively urge against the third extending portion.

14. The electrical connector of claim 11, further comprising an insulating, wherein a receiving cavity runs through the insulating shell along a front-rear direction, the shielding shell is located in the receiving cavity, a rear cover extends from the insulating shell, an inner wall surface of the rear cover urges against an outer wall surface of the shielding shell, a first glue pouring slot is formed between an inner side wall of the rear cover and an outer side wall of the shielding shell, and a second glue pouring slot is formed between the inner side wall of the rear cover and the base.

15. The electrical connector of claim 14, wherein a glue accommodating slot is recessed in a bottom surface of the base, a third glue pouring slot is formed between the glue accommodating slot and the shielding shell, the lower-row terminals are partially exposed from the third glue pouring slot, the first glue pouring slot, the second glue pouring slot and the third glue pouring slot are communicated with each other, and a sealing piece is located in the first glue pouring slot, the second glue pouring slot and the third glue pouring slot.

16. The electrical connector of claim 11, wherein an accommodating slot is recessed in an upper surface of the insulating shell, at least one through hole is located at one of two sides of the insulating shell, the electrical connector further comprises a fixing member located in the accommodating slot, and a soldering pin extends from the fixing member to penetrate through the through hole.

17. The electrical connector of claim 11, wherein an annular groove is recessed in a front end of the insulating shell, and a waterproof ring is located in the annular groove.

18. The electrical connector of claim 11, wherein at least one stopping portion extends into the mating space from the shielding shell, at least one positioning slot is recessed in the base to run through a front surface of the base, and the stopping portion is located in the positioning slot.
